(19) United States
(12) Patent Application Publication
(10) Pub. No.: US 2017/0109964 A1
(43) Pub. Date: Apr. 20, 2017

(54) Game of Chance Embedded in Electronic Message

(71) Applicant: Saber Gaming Technologies, LLC, Maplewood, NJ (US)

(72) Inventor: Matthew Karch, Short Hills, NJ (US)

(73) Assignee: Saber Gaming Technologies, LLC, Maplewood, NJ (US)

(21) Appl. No.: 14/886,639

(22) Filed: Oct. 19, 2015

(51) Int. Cl. G07F 17/32; G07F 17/34

(52) U.S. Cl. CPC G07F 17/3225; G07F 17/34

(57) ABSTRACT

A system generates and transmits an electronic message having an embedded game of chance in response to a request. A request is received from the recipient to play the game of chance and it is determined if the recipient has won. An indication is transmitted to the recipient indicating what the recipient has won. The outcome of the embedded game of chance can be determined prior to transmitting the electronic message to the recipient. The outcome can also be determined after receiving a request from a recipient to play the game of chance. The embedded game and prizes may be branded to be associated with a business. The recipient can receive an electronic coupon or a physical coupon.

### BACKGROUND

The present disclosure relates generally to communications, and more particularly to games of chance embedded in electronic messages.

Businesses use advertising in order to persuade people to purchase the business's product and/or services and keep customers returning for repeat business. Various forms of advertising are used with varying degrees of success. Businesses often focus on a specific demographic for their advertising in order to target customers who the businesses think will be most likely to purchase their product. Businesses need to continually advertise to customers in order to keep the business on a customer's mind so that when the customer is ready to make a purchase, the customer purchases from the businesses that have advertised to them. Returning customers, together with new customers, allow a business to maintain a high level of profit. Distinguishing a particular business is particularly important when many other businesses offer similar products and services. As such, businesses are typically interested in using anything that can be used to attract new customers and keep existing customers returning.

### SUMMARY

In one embodiment, a method includes receiving a request to transmit an electronic message to a recipient where the electronic message contains an embedded game of chance. The electronic message comprising the embedded game of chance is then generated and transmitted to the recipient. A request is received from the recipient to play the game of chance and it is determined if the recipient has won. An indication is transmitted to the recipient indicating what the recipient has won. The outcome of the embedded game of chance can be determined prior to transmitting the electronic message to the recipient. The outcome can also be determined after receiving a request from a recipient to play the game of chance. The embedded game and prizes may be branded to be associated with a business. The recipient can receive an electronic coupon electronically redeemable for free or discounted products. The recipient can also receive a physical coupon that can be redeemed electronically or at a brick and mortar store.

In one embodiment, an apparatus and computer readable medium for generating and transmitting electronic messages having embedded games of chance are also described.

### BRIEF DESCRIPTION OF THE DRAWINGS

FIG. 1 shows depicts an embedded game of chance email system according to one embodiment;

FIG. 2 depicts a flowchart of a method according to one embodiment;

FIG. 3 depicts an electronic message comprising an embedded game of chance; and

FIG. 4 depicts a high-level block diagram of a computer which can be used to implement a user device and/or server.

### DETAILED DESCRIPTION

The present disclosure pertains to embedding games of chance in electronic messages. A user can choose to send one of a plurality of games of chance embedded in an electronic message to a recipient. The user, in various embodiments, may be a friend of the recipient, a business, etc. The recipient can play the game of chance embedded in the electronic message to win products or services offered by or associated with a specific business as well as other prizes. The game of chance may be branded using various indicia associated with a business.

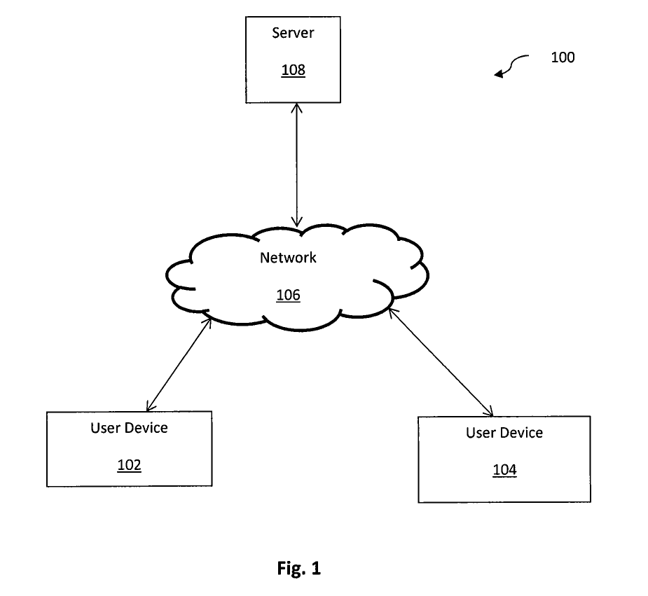

FIG. 1 depicts a system 100 for facilitating games of chance embedded in electronic messages. System 100, in one embodiment, comprises user devices 102 and 104 in communication with server 108 via network 106. User devices 102, 104 can be any device capable of supporting transmission and receipt of electronic messaging, supporting play of a game of chance, and communicating via network 106 with server 108. User devices 102, 104, in one embodiment, can be handheld devices such as a smart phones or tablet computers. In other embodiments, use devices 102, 104 can be personal computers, or other devices.

Server 108, in one embodiment, is a computer but can be any device capable of communicating with user devices 102, 104 via network 106. Network 106 can be any type of wired and/or wireless network supporting communication between devices such as user devices 102, 104 and server 108.

In one embodiment, a user can select one of a plurality of games of chance to be sent to a recipient embedded in an electronic message.

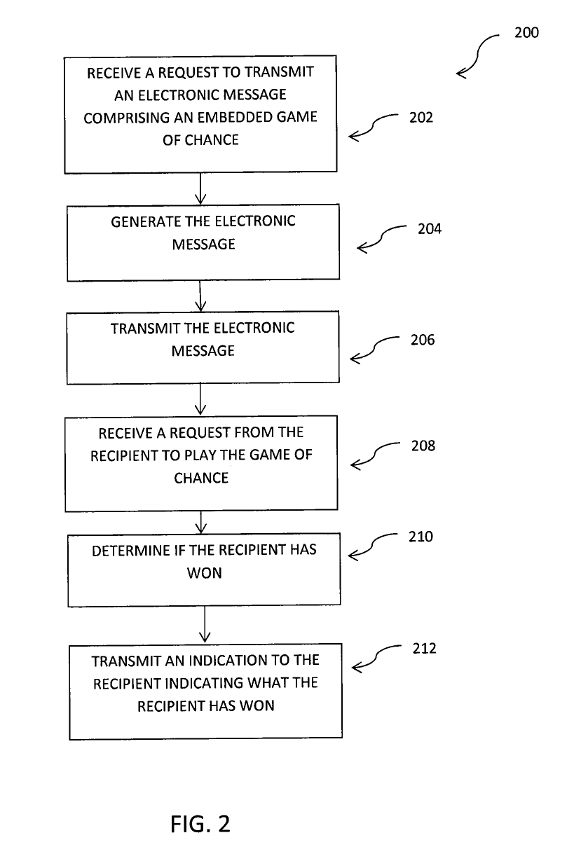

FIG. 2 depicts method 200 for sending a game of chance to a recipient embedded in an electronic message. At step 202, server 108 receives a request from a user via user device 102 through network 106. In one embodiment, the request may be based on user input received from a user at user device 102. User input comprises identification of a recipient, such as a recipient electronic messaging address (e.g., an email address, short message service message identifier, or instant message identifier). User input can also comprise identification of a particular game of chance and one or more winnable prizes to be embedded in the electronic message.

At step 204, an electronic message addressed to the recipient is generated by server 108 based on the user input. The electronic message comprises an embedded game of chance selected by the user and is a type of electronic message (e.g., email, instant message, etc.) based on the user input, etc. Selection of a game of chance may be randomized. An embedded game of chance is a game that is displayed within an electronic message. For example, a user opening an email is presented with the usual information such as sender, subject, recipient, etc. In addition, the body of the email displays a virtual slot machine which the recipient can interact with by selecting certain elements of the virtual slot machine, such as the lever, using a touch screen or mouse. The virtual slot machine contained within the email can be played by the user in a manner similar to how a player would play a real slot machine. Additional details of a game of chance embedded in an electronic message are described in detail below.

At step 206, the electronic message is transmitted from server 108 to a recipient (e.g., a user associated with user device 104, also referred to as a recipient device). For example, an email or SMS message may be transmitted based on the type of message to be sent as selected by a sender.

The recipient views the electronic message and is presented with a game of chance to play as shown and described in further detail below. The recipient can then select to play the game.

At step 208, a request is received at server 108 from the recipient (e.g., a user associated with user device 104) to play the game of chance. In one embodiment, the request is transmitted from a user device associated with the recipient in response to input from the recipient. For example, for a game of chance involving the display of a slot machine to the recipient in the electronic message (shown and described in further detail below), the recipient selecting the lever arm of the slot machine causes the request of step 208 to be sent from the user device associated with the recipient to server 108. In one embodiment, the recipient can select a link contained in the electronic message to indicate that the recipient would like to play the game of chance.

At step 210, in response to the request, server 108 performs operations to determine the outcome of the game of chance. Based on the outcome of the game, it is determined whether the recipient has won or lost. At step 212, server 108 transmits an indication to the user device associated with the recipient indicating the outcome of the game of chance and, if the recipient has won, an indication of what the recipient has won. The recipient can then claim their winnings in one of a variety of ways as described below. It should be noted that the recipient can also be informed that they have won nothing.

In one embodiment, the game of chance embedded in the electronic message comprises text, one or more images, and/or one or more animations displayed to the recipient to simulate a particular game of chance. For example, an image of a slot machine can be presented to the user with a lever that may be selected to cause the slot machine to appear to operate. After the user selects the lever, the slot machine can be animated in order to make it appear that reels of the slot machine are rolling. In response to user input and/or after a predetermined period of time, the reels are stopped to display a sequence of images depicted on the stopped reels. The sequence may be associated with a winning combination.

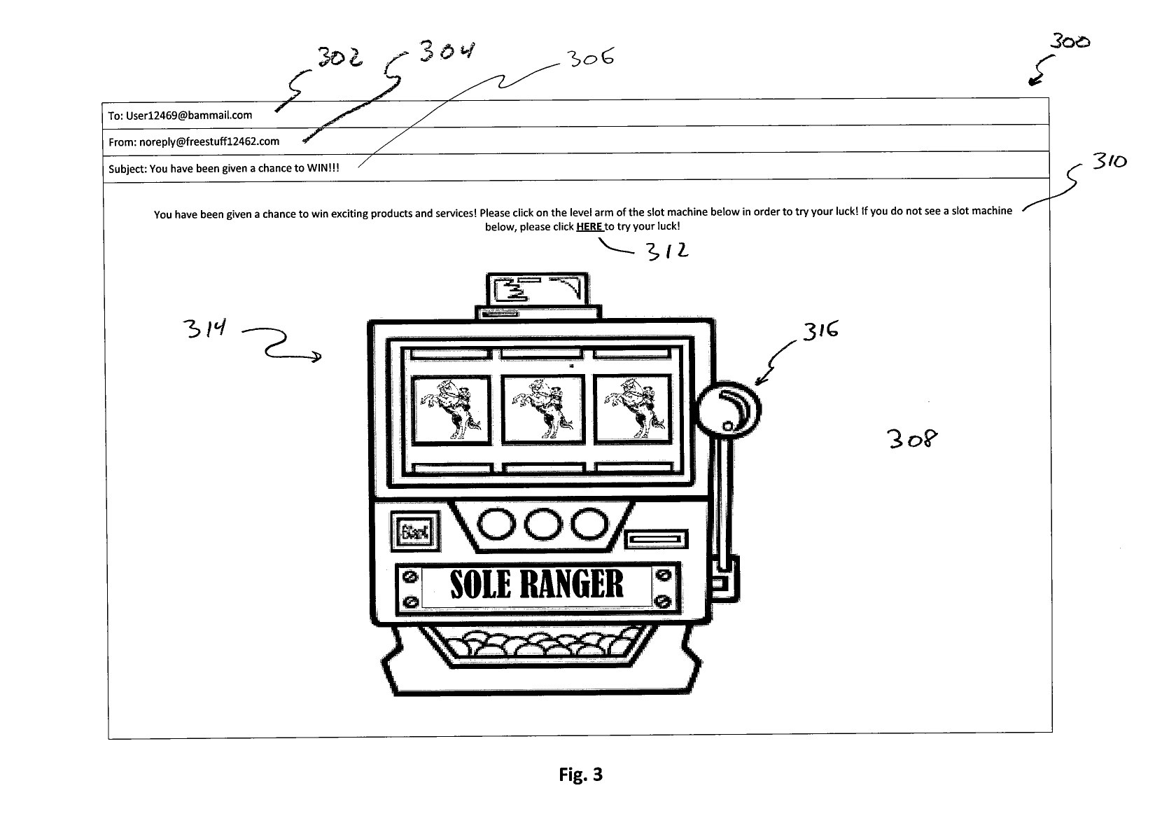

FIG. 3 depicts an electronic message, in this example, email 300, which contains an embedded game of chance. Email 300 is shown having a “To” line 302, and “From” line 304, and a “Subject” line 206, which indicate an email account to which the email is directed, an email account from which the email originated, and a subject of the email, respectively. Body 308 of email 300 contains a message from the sender (e.g., the email account associated with the “From” line 304) to the recipient (e.g. the email account associated with the “To” line 302) of the email. In this example, body 300 has text 310 indicating that the recipient has been given a chance to win products and services. Text 310 also instructs the recipient to click on lever arm 316 of simulated slot machine 314 in order to try their luck. Text 310 also provides link 312 which can be selected by a recipient to play the game of chance if simulated slot machine 314 should not be shown in body 308 of email 300 for some reason (e.g. body 308 is not capable of displaying simulated slot machine 314). In response to a user selecting lever arm 316 (e.g., clicking lever arm 316) simulated slot machine 314 is shown operating in a manner similar to that of a real slot machine. For example, the rollers of the slot machine begin spinning and then stop to show an image or icon. Simulated slot machine 314 is shown having branding related to “Sole Ranger” which is a fictitious entertainment property. As shown in FIG. 3, a name plate identifies simulated slot machine 314 as being named “Sole Ranger” and the rollers are shown displaying a cowboy atop a rearing horse. The rollers and other parts of simulated slot machine 314 may have additional text or images related to “Sole Ranger.”

Any type of game of chance can be embedded into the electronic message. For example, scratch-off cards (e.g. a card having a material covering text or an image indicating whether a player has won something), a spinning wheel (e.g., a spinnable wheel comprising a plurality of segments and a pointer to indicate a particular segment after the wheel has stopped spinning), card games, bingo, and dice games may be simulated. Any type of game or game experience that has an element or an appearance of randomness may be simulated.

In one embodiment, a game of chance is embedded in the electronic message and software code required to play the game of chance is contained in and transmitted with the electronic message. For example, for an email having a virtual slot machine embedded in the email, all of the software, code, etc. to allow a recipient to play the virtual slot machine is contained in the email. In one embodiment, a prize, such as a coupon for a free or discounted product or service is also included in the email but is only accessible and/or displayed to the recipient if the recipient wins the game of chance. In such embodiments, all operations pertaining to the electronic message having the embedded game of chance (in this example, an email with an embedded slot machine) are contained within the electronic message and can be performed by the user device on which the recipient retrieves and reads the electronic message (e.g., user device 104).

In another embodiment, portions of operations to support the game of chance embedded in the electronic message may be performed by various devices. For example, an electronic message comprising a game of chance is sent to a recipient associated with user device 104. The recipient can open the message and select to play the game of chance. In response to the user selecting to play the game of chance, information is transmitted from user device 104 to server 108 via network 106. Server 108 can perform operations to determine whether the user has won. Server 108 can then generate and transmit prize information as necessary (e.g., if the user has won). In such embodiments, server 108 performs operations to facilitate the game of chance displayed to the recipient and embedded in the electronic message. Server 108 transmits data as necessary to a user device (e.g., user device 104) based on the outcome of the game of chance and what the user may have won based on the outcome of the game of chance.

In one embodiment, the outcome of the game of chance is not determined until a recipient opts to take their chance and play the game. In such embodiments, after the recipient selects to play the game of chance, the outcome is determined based on one or more algorithms associated with the game of chance. In one embodiment, these algorithms can be contained in the electronic message which contains the game of chance. In other embodiments, the algorithms can be stored and/or located remotely, such as on server 108, and can be executed in response to a request from a recipient to play the game of chance. In embodiments in which the algorithms are stored remotely, the algorithms are executed in response to a request and results of the output of the algorithm (e.g., whether the player won) are transmitted from the server. In one embodiment, additional data, such as a coupon for a free or discounted product or service, may be transmitted from the server with an indication that the player has won.

In one embodiment, the outcome of the game of chance is determined prior to transmission of the electronic message to the recipient. In these embodiments, the game of chance presented to the user is playable by the recipient but the outcome has been previously determined. The game of chance displayed to the user depicts the predetermined outcome in response to recipient input requesting to play the game of chance. The game of chance may be animated and provide the recipient with the impression that the outcome is random and/or has not been previously determined.

A player who wins a game of chance can be awarded one or more prizes. Prizes can be free or discounted products and/or services or other things. Prizes can be sent to a user in the form or coupons and/or certificates. Such coupons and/or certificates can be delivered electronically or physically (e.g., via regular mail). A user may redeem the coupons and/or certificates electronically or using physical coupons and/or certificates. In one embodiment, a user can print a copy of a coupon and/or certificate in order to redeem it at a brick and mortar store.

Each game of chance can be branded. A branded game is a game that contains one or more images, indicia, phrases, and/or concepts associated with a business or entertainment property such as a product, service, actor, character, movie, television show, etc. For example, a slot machine may be titled after a television show and have icons representing various characters from the television show on the rollers of the virtual slot machine. A card game may depict images related to a movie on the back of the cards. A bingo game may replace letters and/or numbers with characters, objects, or concepts related to a television show. In one embodiment, a branded game is associated with a particular business and links to a website of the business are presented to a user while selecting and/or playing a branded game. Users can select a link to be directed to the related business's website in order to view the goods and/or services the business offers and to make purchases.

In one embodiment, electronic messages are generated using a web interface supported by server 108 and accessed by a user via user device 102. A user enters information into the web interface comprising a recipient identification, a game of chance, and prize information. The information is then transmitted from user device 102 to server 108 for processing (e.g., to generate and send an electronic message comprising an embedded game of chance.) In one embodiment, electronic messages are generated using a mobile device application. For example, a mobile device application loaded onto user device 102 can be used to allow a user to enter information comprising a recipient identification, a game of chance, and prize information. The information is then transmitted from user device 102 to server 108 for processing to generate and send an electronic message comprising an embedded game of chance.

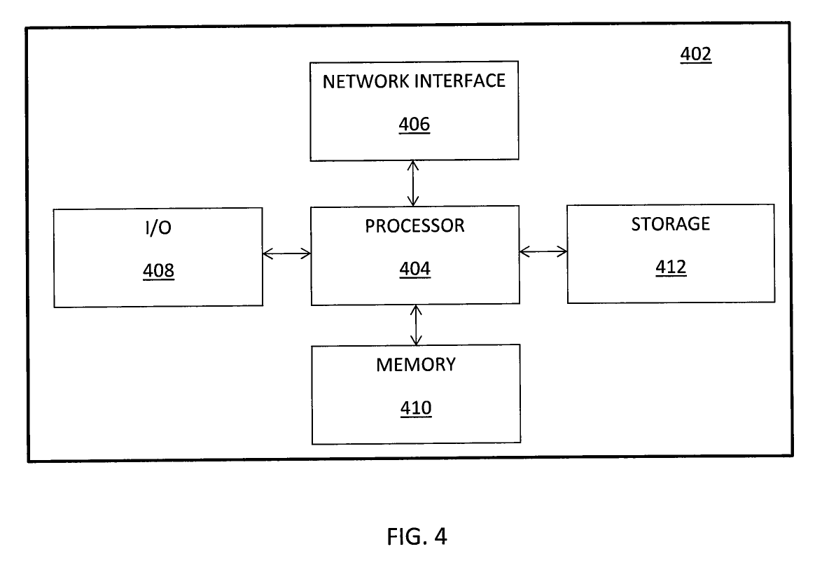

User devices 102, 104 and server 108 can each be implemented using a computer. A high-level block diagram of such a computer is illustrated in FIG. 4. Computer 402 contains a processor 404 which controls the overall operation of the computer 402 by executing computer program instructions which define such operation. The computer program instructions may be stored in a storage device 412, or other computer readable medium (e.g., magnetic disk, CD ROM, etc.), and loaded into memory 410 when execution of the computer program instructions is desired. Thus, the method steps of FIG. 2 can be defined by the computer program instructions stored in the memory 410 and/or storage 412 and controlled by the processor 404 executing the computer program instructions. For example, the computer program instructions can be implemented as computer executable code programmed by one skilled in the art to perform an algorithm defined by the method steps of FIG. 2. Accordingly, by executing the computer program instructions, the processor 404 executes an algorithm defined by the method steps of FIG. 2. The computer 402 also includes one or more network interfaces 406 for communicating with other devices via a network. The computer 402 also includes input/output devices 408 that enable user interaction with the computer 402 (e.g., display, keyboard, mouse, speakers, buttons, etc.) One skilled in the art will recognize that an implementation of an actual computer could contain other components as well, and that FIG. 4 is a high level representation of some of the components of such a computer for illustrative purposes.

The foregoing Detailed Description is to be understood as being in every respect illustrative and exemplary, but not restrictive, and the scope of the inventive concept disclosed herein is not to be determined from the Detailed Description, but rather from the claims as interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A method comprising:
generating an electronic message comprising an embedded game of chance; and
transmitting the electronic message to a recipient device.

2. The method of claim 1, further comprising:
receiving a request from a recipient to play the game of chance;
determining if the recipient has won; and
transmitting an indication to the recipient device indicating what the recipient has won.

3. The method of claim 1, wherein an outcome of the embedded game of chance is determined prior to the transmitting the electronic message to the recipient device.

4. The method of claim 2, wherein an outcome of the embedded game of chance is determined after receiving the request from the recipient to play the game of chance.

5. The method of claim 1, wherein the embedded game of chance is branded.

6. The method of claim 2, the transmitting the indication to the recipient device indicating that the recipient has won further comprises:
transmitting a coupon to the recipient device.

7. The method of claim 6, wherein the coupon is associated with branding of the game of chance.

8. The method of claim 1, further comprising:
receiving a request to transmit the electronic message to the recipient device comprising the embedded game of chance.

9. An apparatus comprising:
a processor; and
a memory to store computer program instructions, the computer program instructions when executed on the processor cause the processor to perform operations comprising:
generating an electronic message comprising an embedded game of chance; and
transmitting the electronic message to a recipient device.

10. The apparatus of claim 9, the operations further comprising:
receiving a request from a recipient to play the game of chance;
determining if the recipient has won; and
transmitting an indication to the recipient device indicating what the recipient has won.

11. The apparatus of claim 9, wherein an outcome of the embedded game of chance is determined prior to the transmitting the electronic message to the recipient device.

12. The apparatus of claim 10, wherein an outcome of the embedded game of chance is determined after receiving the request from the recipient to play the game of chance.

13. The apparatus of claim 9, wherein the embedded game of chance is branded.

14. The apparatus of claim 10, the transmitting the indication to the recipient device indicating that the recipient has won further comprises:
transmitting a coupon to the recipient device.

15. The apparatus of claim 14, wherein the coupon is associated with branding of the game of chance.

16. The apparatus of claim 9, the operations further comprising:
receiving a request to transmit the electronic message to the recipient device comprising the embedded game of chance.

17. A computer readable medium storing computer program instructions, which, when executed on a processor, cause the processor to perform operations comprising:
generating an electronic message comprising an embedded game of chance; and
transmitting the electronic message to a recipient device.

18. The computer readable medium of claim 17, the operations further comprising:
receiving a request from a recipient to play the game of chance;
determining if the recipient has won; and
transmitting an indication to the recipient device indicating what the recipient has won.

19. The computer readable medium of claim 17, wherein an outcome of the embedded game of chance is determined prior to the transmitting the electronic message to the recipient device.

20. The computer readable medium of claim 18, wherein an outcome of the embedded game of chance is determined after receiving the request from the recipient to play the game of chance.

21. The computer readable medium of claim 17, wherein the embedded game of chance is branded.

22. The computer readable medium of claim 18, the transmitting the indication to the recipient device indicating that the recipient has won further comprises:
transmitting a coupon to the recipient device.

23. The computer readable medium of claim 17, the operations further comprising:
receiving a request to transmit the electronic message to the recipient device comprising the embedded game of chance.
